(19) United States
(12) Patent Application Publication
(10) Pub. No.: US 2004/0067120 A1
(43) Pub. Date: Apr. 8, 2004

(54) Mechanical fasteners with individual indicia of their size and/or other characteristics

(76) Inventor: Brian William Speer, Harleton, TX (US)

Correspondence Address: Brian William Speer, 11580 FM 450 N, Harleton, TX, 75651, US

(21) Appl. No.: 10/267,113

(22) Filed: Oct. 7, 2002

(51) Int. Cl. F16B 31/02

(52) U.S. Cl. 411/14

(57) ABSTRACT

A mechanical fastener such as a bolt or a nut for a bolt bears on its surface at least one indicium of at least one characteristic of the mechanical fastener, preferably including at least the thread diameter. As a result, such fasteners are more readily separated from similar appearing fasteners with which they may become mingled, and mistakes arising from inadvertent mismatching of two parts of a threaded fastener are minimized.

### CROSS REFERENCE TO RELATED PERSONAL DISCLOSURE DOCUMENT

Priority for conception of the invention described in this application is claimed from Personal Disclosure Document No 510466 filed on Apr. 22, 2002.

### BACKGROUND OF THE INVENTION

Mechanical fasteners such as bolt and nut combinations, screws, rivets, and the like are manufactured in numerous sizes, some of which are so close to one another that they are difficult, if not literally impossible, to distinguish from one another by normal human vision alone. For example, a bolt 31/32 of an inch in diameter differs in diameter from a 25 millimeter metric-sized bolt by less than 002 of an inch Furthermore, many of these fasteners have other characteristics that are difficult to distinguish visually from those of some other similar fasteners. Such characteristics include left and right hand threading, thread spacing, head sizes and shapes, and the like.

In addition to being difficult or impossible to determine by unaided human vision alone and to being important to the effective use of mechanical fasteners, these characteristics have another important common property: They could in principle be determined with the aid of tools such as magnifiers, rulers, micrometers, and the like that are readily available to many non professional users. Also, these fasteners are usually sold in packages on which indicia of these characteristics are printed. However, the large number of nonprofessional users of such fasteners in particular are likely, deliberately or otherwise, to remove such fasteners from their packages without immediately using the fasteners and thereby to mingle fastens of different sizes and/or other characteristics that can not be readily separated by ordinary visual examination. This results in wasted time and general inefficiency.

It has been known in the art to mark bolt heads with indicia of some characteristics. For example, copies of two pages of the Fastener Reference Guide accompany this application This shows marks on bolt heads to indicate the manufacturer of the bolt and various grades of steel of which the bolts are made. However, it is known or believed by the applicant that all of these characteristics indicated by indicia on bolts in the prior art are characteristics that are literally impossible to discern from examining the bolts visually and/or with tools readily available to a normal non-professional user. The grade of steel, for example, can normally be determined only with the use of metallurgical examination, which requires the use of high-power microscopes and often of special etchant chemicals. Such determinations, even in a large company, are usually performed only by a specialized group of persons distinct from most users of mechanical fasts and in an expensively equipped laboratory.

### OBJECT OF THE INVENTION

A major object of this invention is to provide mechanical fasteners that are more readily distinguished by unaided human vision, without any need to use tools, when the fasteners are mingled with other fasteners of similar but not identical shapes and sizes. Another object is to prevent waste of fasteners and safety hazards by unintended use of similar but actually not fully compatible fasteners. For example, if a workman attempts to secure a bolt by a nut that is not, even though it appears to be, the correct size for the bolt, there are at least two possible undesirable consequences. The incompatible bolt may appear to fit sufficiently well in the early stages of being mated with an erroneously selected nut that a worker, believing that the two parts of the fastener actually are compatible, may apply sufficient force to strip or otherwise damage the threads of one or both of the nut and the bolt, so that the nut and the bolt become too damaged to be reused before the worker becomes convinced of the incompatibility. Even worse, the worker may never become convinced of the incompatibility between the nut and the bolt thereby manufacturing a fastened object that appears to be fastened to form a joint with a strength tat is expected to meet or exceed a specified value and would do so if the bolt and nut forming the joint had been fully compatibly threaded but does not accomplish this intended objective because of the unintentional use together of a bolt and a nut that are not fully compatible. Such a joint, of course, may fail when stressed, with catastrophic results.

### SUMMARY OF THE INVENTION

The object of the invention is achieved by providing individual mechanical fasteners with lexical indicia of their size(s) and/or other characteristics that are difficult or impossible reliably to distinguish in some instances by visual examination alone with normal human vision, even though the characteristics could be determined by the use of vision with low-power magnification, calipers, micrometers, closely marked rulers or scales, and like tools and visual aids readily available to and affordable by non-professional users of mechanical fasteners. For the purposes of this description, single letters, numbers, including both conventional and decimal fractions, and symbols such as #, $, *, †, ‡, ▴, ≃, ▾, [symbol] , ♀, ♂, ♦, [symbol] , and the like are considered to be lexical along with more conventional words Embodiments of the invention include the fasteners bearing lexical indicia of said characteristics and processes of causing such indicia to be present on fasteners.

### BRIEF DESCRIPTION OF THE DRAWINGS

The four drawing figures illustrates examples of the invention but do not limit it in any way except to whatever extent features of the drawings may be incorporated into the appended claims. All of the drawings are orthogonal projections of a hex head bolt or a hex-head nut designed to mate with a bolt. All of the features depicted are conventional except for the indicia as follows:

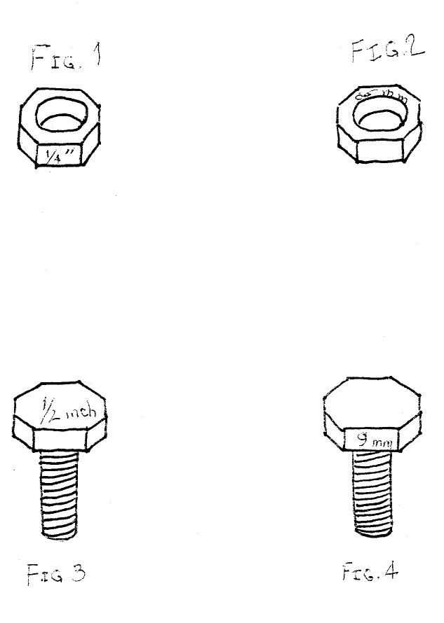

In FIG. 1, the indicia “¼″” on a front ace of a nut indicate a nut with a thread diameter of one-quarter inch;

In FIG. 2, the indicia “65 mm” on the top face of a nut indicate a nut with a thread diameter of six and one-half millimeters;

In FIG. 3, the indicia “½inch” on a front face of a nut indicate a nut with a thread diameter of one-half inch; and

In FIG. 4, the indicia “9 mm” on a front face of a nut indicate a nut with thread diameter of nine millimeters.

### DETAILED DESCRIPTION OF THE INVENTION, INCLUDING PREFERRED EMBODIMENTS

Indicia are preferably placed on a surface of a faster according to the invention that does not interact with any other surface of the same or another fastener element to achieve the bonding that the fastener effects. Thus, for example: the indicia may be placed: on one or more of the sides of a hexagonal nut and/or hexagonal bolt head; on any part of the top of a bolt head; on a portion of the top or bottom of a nut between its threaded sings and its edge; on any unthreaded exterior cylindrical surface of a bolt, nut, or screw; on the head of a screw or rivet; or the like. More preferably, for easy visibility, indicia are placed on a flat rather than a curved surface.

Independently, the fasteners according to the invention are preferably selected from the group consisting of threaded bolts, threaded nuts for threaded bolts, and threaded receptacles for threaded bolts, because it is believed that fasteners of these types are most likely to be mixed with others of slightly different sizes or other characteristics and are also more likely to damage each other and/or constitute a hidden defect in a finished item when inadvertently incompatibly mated.

A characteristic indicated by one or more indicia according to the invention must be a characteristic that satisfies all of the following criteria: (1) The characteristic, in the absence of any indicia according to the invention, must be one that is not always reliably distinguishable by unaided human vision alone when a fastener according to the invention is mixed with anther fastener having a characteristic that is qualitatively similar to, but not quantitatively identical with, the characteristic indicated by one or more indicia according to the invention; (II) in the absence of indicia according to the invention, the characteristic must be reliably distinguishable in principle with the aid of at least one of small power magnification and precise direct length- and/or diameter-measuring tools but without use of any of chemical etchants, electrochemical treatments of the surface of the fastener, high-power magnification, chemical and/or metallurgical analysis of the material of which the fasteners are composed, spectrometers, reflectometers, interferometers, magnetometers, X-ray analysis, and interactions with beams of sub-atomic particles; and (III) the determination in principle described in criterion (II) described immediately above must require more time than is required to look at the one or more indicia according to the invention and learn therefrom the characteristic in question. For purposes of this description: the term “low-power magnification” means magnification that is not greater than 50 or more preferably, with increasing preference in the order given, is not greater than, 40, 30, 20, 15, 10, 8, 6, 4, 3.0, 2.0, or 15 power, and independently, the term “high-power magnification” means power that is at least 60 and more preferably, with increasing preference in the order given, is at least 65, 70, 75, 80, 90, 100, 120, or 150 power.

A characteristic of a faster according to the invention that is indicated by one or more indicia according to the invention preferably is selected from the group consisting of. (1) the length of the entire fastener and/or of a portion thereof that has a special function in achieving the fastening expected from said fastener, (2) if the fastener includes a cylindrical portion that has a special function in achieving the fastening expected from said fastener, the diameter of said cylindrical portion; and (3) if the fastener includes a threaded portion of said fastener that secures the intended fastening by mating with another threaded surface of opposite threading gender, the following characteristics of said treaded portion: (3.1) its diameter, (3.2) its thread pitch (i.e., the distance between threads or the number of threads per unit length along a portion of the surface of said threaded portion of the faster in a diction parallel to the axis of the threading, (3.3) the shape of the threads on said threaded portion, and (3.4) the handedness of the threads on said threaded portion.

More preferably, a fastener according to the invention includes a cylindrical portion that has a special function in achieving the fastening expected from said fastener, and the diameter of said cylindrical portion is one of the characteristics indicated by at least one indicium according to the invention. Still more preferably, a fastener according to the invention includes a threaded portion of said fastener that secures the intended fastening by mating with another threaded surface of opposite threading gender in a second distinct mechanical fastener, and one or more indicia according to the invention indicate at least one of the following characteristics of said threaded portion: (1) its diameter, (2) its thread pitch, (3) the shape of the threads, and (4) the handedness of the threads, the diameter of said threaded portion being most preferably included irrespective of the presence of indicia to indicate any other characteristic.

Indicia according to the invention may be added to at least one surface of pre-existing fasteners by any suitable means. Some non-limiting examples are: mechanical stamps that form indicia by indenting the surface of the fastener; transferring the indicia from an inked roll to the surface of the fastener; and adhering one or more printed labels to a surface of the fastener. Additionally or alternatively, the fasteners can be manufactured with indicia already in place by injection molding, numerically controlled machining, or a like process.

The invention claimed is:

1. A mechanical fastener having on its surface one or more lexical indicia that can be used with normal human vision to distinguish a characteristic of the fastener that relates to its use in fastening, said characteristic satisfying all of the following criteria:
I the characteristic, in the absence of said indicia, is not always reliably distinguishable by unaided human vision alone when said fastener is mingled with one or more other fasteners having a characteristic that is qualitatively similar to, but not quantitatively identical with, the characteristic indicated by one or more indicia according to the invention;
II the characteristic is reliably distinguishable in principle, even when said fastener is mingled with one or more other fasteners having a characteristic that is qualitatively similar to, but not quantitatively identical with, said characteristic by human vision with the aid of at least one of small power magnification and precise direct length- and/or diameter-measuring tools but without use of any of chemical etchants, electrochemical treatments of the surface of the fastener, high-power magnification, chemical and/or metallurgical analysis of the material of which the fastener is composed, spectrometers, reflectometers, interferometers, magnetometers, X-ray analysis, and interactions with beams of sub-atomic particles; and
III the determination in principle described in criterion (II) immediately above requires more time than is required to look at the one or more indicia according to the invention and learn therefrom the characteristic in question.

2. A mechanical fastener according to claim 1, wherein at least one of said lexical indicia appears on a flat surface of said fastener.

3. A mechanical fastener according to claim 2, wherein:
said fastener includes a threaded portion that effects fastening by mating with another threaded surface of opposite threading gender in a second distinct mechanical fastener, and
one or more of said indicia indicate at least one of the following characteristics of said threaded portion: (1) its diameter, (2) its thread pitch, (3) the shape of the threads, and (4) the handedness of the threads.

4. A mechanical fastener according to claim 3, wherein the diameter of said threaded portion is indicated by at least part of said lexical indicia.

5. A mechanical fastener according to claim 1, wherein:
said fastener includes a threaded portion that effects fastening by mating with another threaded surface of opposite threading gender in a second distinct mechanical fastener, and
one or more of said indicia indicate at least one of the following characteristics of said threaded portion: (1) its diameter, (2) its thread pitch, (3) the shape of the threads, and (4) the handedness of the threads.

6. A mechanical fastener according to claim 5, wherein the diameter of said threaded portion is indicated by at least part of said lexical indicia.

7. A mechanical fastener according to claim 6 that is selected from the group consisting of a bolt, a nut for a bolt, and a threaded receptacle for a bolt.

8. A mechanical fastener according to claim 5 that is selected from the group consisting of a bolt, a nut for a bolt, and a threaded receptacle for a bolt.

9. A mechanical fastener according to claim 4 that is selected from the group consisting of a bolt, a nut for a bolt, and a threaded receptacle for a bolt.

10. A mechanical fastener according to claim 3 that is selected from the group consisting of a bolt, a nut for a bolt, and a threaded receptacle for a bolt.

11. A mechanical fastener according to claim 2 that is selected from the group consisting of a bolt, a nut for a bolt, and a threaded receptacle for a bolt.

12. A mechanical fastener according to claim 1 that is selected from the group consisting of a bolt, a nut for a bolt, and a threaded receptacle for a bolt.

13. A process of manufacturing a mechanical fastener according to claim 12.

14. A process of manufacturing a mechanical fastener according to claim 11.

15. A process of manufacturing a mechanical fastener according to claim 10.

16. A process of manufacturing a mechanical fastener according to claim 9.

17. A process of manufacturing a mechanical fastener according to claim 4.

18. A process of manufacturing a mechanical fastener according to claim 3.

19. A process of manufacturing a mechanical fastener according to claim 2.

20. A process of manufacturing a mechanical fastener according to claim 1.
